(19) United States
(12) Patent Application Publication
(10) Pub. No.: US 2015/0167725 A1
(43) Pub. Date: Jun. 18, 2015

(54) PIN LOCK APPARATUS AND HELMET INCLUDING THE SAME

(71) Applicant: Yong Ho Lee, Incheon (KR)

(72) Inventor: Yong Ho Lee, Incheon (KR)

(73) Assignee: HJC CORP., Gyeonggi-do (KR)

(21) Appl. No.: 14/413,389

(22) PCT Filed: Jul. 12, 2012
(86) PCT No.: PCT/KR2012/005523

§ 371 Date: Jan. 7, 2015

(51) Int. Cl. F16B 39/24; A42B 3/22

(52) U.S. Cl. CPC F16B 39/24; A42B 3/221

(57) ABSTRACT

Provided are a pin lock apparatus and a helmet including the same. The pin lock apparatus includes a first pin unit having an engagement groove and a first stopper protruding on a bottom surface of the engagement groove, and a second pin unit having an engagement protrusion engaged with the engagement groove and a second stopper protruding on an end surface of the engagement protrusion, the second pin unit being coupled to the first pin unit through a lock fitting groove formed in the shield. The first pin unit and the second pin unit can rotate together when the first stopper and the second stopper contact each other by engagement with respect to a rotation direction.

### TECHNICAL FIELD

The present disclosure relates to a pin lock apparatus for supporting a shield coupled to a helmet body and a helmet including the same.

### BACKGROUND ART

When driving a two-wheeled vehicle such as a motorcycle, a driver should wear a helmet, and a shield is provided at an opening in a front surface of a helmet body in order to ensure a forward sight of the driver.

The helmet has a sealed structure which does not allow good air ventilation between its inside and the outside. For this reason, the inside of the shield may become humid due to breathing of a helmet wearer. In addition, the shield exposed out of the helmet is generally made of plastic to ensure a sight, but the surface of the shield may be damaged or scratched due to external impurities.

To solve this problem, a pin lock apparatus mounted to a shield to couple a moisture-proof lens to an inner side of the shield and also couple a shield protection lens to an outer side of the shield as well as a helmet including the pin lock apparatus is known in the art. The pin lock apparatus and the helmet including the same are disclosed in Korean Patent Registration No. 10-1053160 (Jul. 26, 2011).

However, in the existing pin lock apparatus, the shield protection lens may be coupled to an outer side of the shield as tightly as desired by the wearer, but the moisture-proof lens is simply coupled to the inner side of the shield and its tightness cannot be adjusted, different from the shield protection lens.

### DISCLOSURE

### Technical Problem

The present disclosure is directed to providing a pin lock apparatus, which may allow easy coupling of tens respectively to inner and outer sides of a shield, and a helmet including the same.

### Technical Solution

In one general aspect, the present disclosure provides a pin lock apparatus of a shield coupled to a helmet body, which includes: a first pin unit having an engagement groove and a first stopper protruding on a bottom surface of the engagement groove; and a second pin unit having an engagement protrusion engaged with the engagement groove and a second stopper protruding on an end surface of the engagement protrusion, the second pin unit being coupled to the first pin unit through a lock fitting groove formed in the shield, wherein the first pin unit and the second pin unit rotate together when the first stopper and the second stopper contact each other by engagement with respect to a rotation direction.

In another general aspect the present disclosure provides a helmet, which includes: a helmet body; a shield; and the pin lock apparatus described above

### Advantageous Effects

If the present disclosure is applied, since only one of a first pin unit and a second pin unit may rotate or both of the first pin unit and the second pin unit may rotate together according to whether a first stopper and a second stopper contact each other by engagement, lens at inner and outer sides of the shield may be coupled to a pin lock apparatus as tightly as desired, so that the lens may foe coupled to the inner and outer sides of the shield in an optimal state as desired by the wearer.

In addition, since a front surface of the coupling member is coupled to contact an insertion restriction surface provided at the second pin unit, when a force is applied to rotate the first pin unit, the second pin unit may rotate, and simultaneously the coupling member may be coupled to the first pin unit and the second pin unit to satisfy suitable tightness not to release the coupling between the first pin unit and the second pin unit

In addition, since an eccentric direction is displayed at the second pin anti-separation unit, a location of an eccentric shaft may be known, and thus the tightness of the lens may be conveniently adjusted.

In addition, since the first pin eccentric shaft has a length greater than a thickness of at least one lens coupled to the first pin eccentric shaft, if a first pin unit is rotated to apply a tensile force to the lens coupled to the first pin eccentric shaft, an end of the lens is separated due to a compression force generated at the end of the lens, which facilitates easier attachment and detachment of the lens.

### DESCRIPTION OF DRAWINGS

FIG. 1 is an exploded perspective view showing a pin lock apparatus according to an embodiment of the present disclosure.

FIG. 2 is a perspective view showing a first pin unit and a second pin unit employed in the pin lock apparatus according to an embodiment of the present disclosure.

FIGS. 3(a), 3(b) and 3(c) are diagrams for illustrating operations of the pin lock apparatus according to an embodiment of the present disclosure.

FIGS. 4(a) and 4(b) are diagrams for illustrating a method for adjusting the tightness of lens coupled to inner and outer sides of a shield by the pin lock apparatus according to an embodiment of the present disclosure.

FIG. 5 is an exploded perspective view showing a pin lock apparatus according to another embodiment of the present disclosure.

FIG. 8 is a perspective view for illustrating a coupling state of the pin lock apparatus and the shield according to an embodiment of the present disclosure.

FIG. 7 is a perspective view showing a helmet according to an embodiment of the present disclosure.

### BEST MODEL

Hereinafter, the embodiments of the present disclosure will be described in detail with reference to accompanying drawings so that the embodiments may be easily implemented by those skilled in the art. However, the present disclosure may be implemented in various ways without being limited to the embodiments. In addition, in the drawings, well-known elements or components may be omitted to avoid unnecessarily obscuring the presented embodiments, and like reference numerals denote like elements throughout the specification.

In the entire specification of the present disclosure, when any member is located “on” another member, this includes a case in which still another member is prevent between both members as well as a case in which one member is in contact with another member.

In the entire specification of the present disclosure, when any portion “includes” any component, this does not exclude other components but means that any other component can be further included, unless stated otherwise, in the entire specification of the present disclosure, the term representing the degree such as “about” and “substantially” means that any value is identical or close to a suggested numeral when an inherent fabrication error is proposed, and this is used for preventing any unscrupulous infringer from unfairly using the disclosure containing an exact or absolute numeral, which is mentioned for better understanding of the present disclosure. In the entire specification of the present disclosure, a “step . . . ” or a “step of . . . ” does not mean a “step for . . . ”.

In the entire specification of the present disclosure, the term “combinations thereof” included in a Markush form means at least one mixture or combination selected from the group consisting of components listed in the Markush form, and this means that at least one selected from the group consisting of these components Is included.

Hereinafter, the present disclosure will be described in detail with reference to the accompanying drawings.

First, a pin lock apparatus 10 according to an embodiment of the present disclosure (hereinafter, also referred to as ‘the pin lock apparatus’) will be described.

The pin lock apparatus 10 plays a role of adjusting tightness of lens 70 coupled to inner and outer sides of a shield 50.

The pin lock apparatus 10 includes a first pin unit 11. In addition, the pin lock apparatus 10 includes a second pin unit 13. The second pin unit 13 is coupled to the first pin unit 11 through a lock fitting groove 51 formed in the shield 50.

The lock fitting groove 51 may be formed at a place where the pin lock apparatus 10 is provided. For example, reference to FIG. 6, the lock fitting grooves 51 may foe formed at both sides of the shield 50 so that the pin lock apparatuses 10 may be provided at both sides of the shield 50 in order not to disturb a sight of a helmet wearer.

For example, the first pin unit 11 may be an outer pin unit coupled at an outer side of the helmet body 30 based on the shield 50, and the second pin unit 13 may be an inner pin unit coupled at an inner side of the helmet body 30 based on the shield 50.

Hereinafter, the first pin unit 11 will be assumed as an outer pin unit, and the second pin unit 13 will be assumed as an inner pin unit, for convenience.

An engagement groove 111 is formed in the first pin unit 11. A first stopper 112 protrudes on a bottom surface of the engagement groove 111.

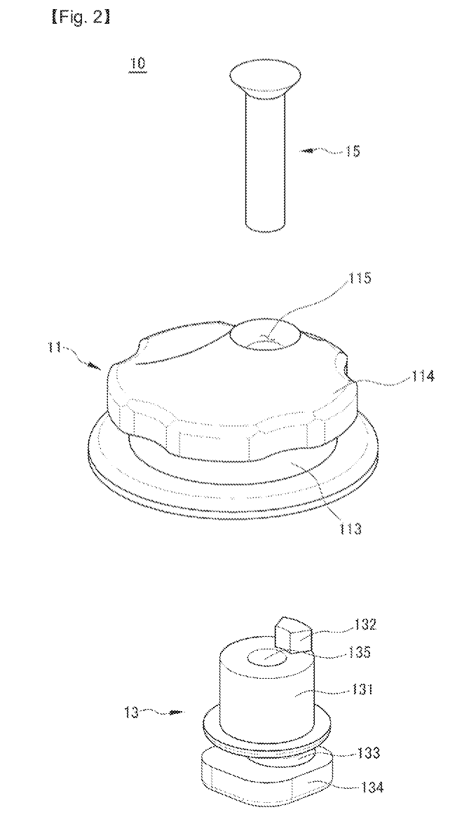

Referring to FIG. 2, the engagement groove 111 may be formed in an end surface of the first pin unit 11.

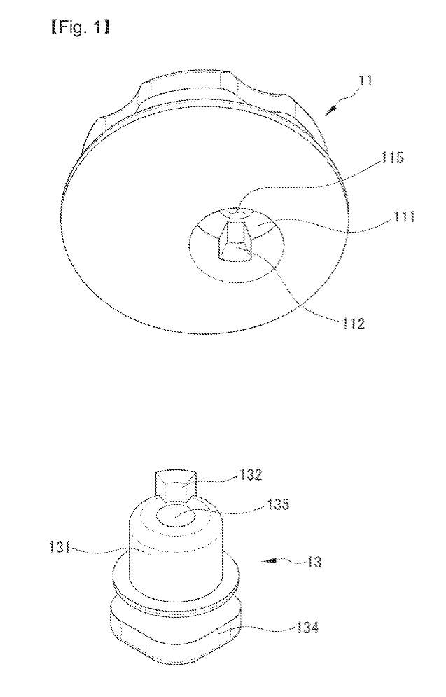

The first stopper 112 has a protruding shape to contact the second stopper 132 by engagement as described later. For example, referring to FIGS. 1 and 2, the first stopper 112 may protrude so that both side surfaces of the first stopper 112 may have vertical planes.

An engagement protrusion 131 is formed at the second pin unit 13. The engagement protrusion 131 engages with the engagement groove 111. In addition, a second stopper 132 protrudes on an end surface of the engagement protrusion 131.

Referring to FIGS. 1, 2 and 5, the engagement protrusion 131 is shaped to be inserted into the engagement groove 111. At this time, the engagement protrusion 131 may rotate in a state of being inserted into the engagement groove 111. For example, the engagement protrusion may be a circular protrusion, and the engagement groove may be a circular groove.

The second stopper 132 has a protruding shape to contact the first stopper 112 by engagement as described later. For example, referring to FIGS. 1 and 2, the second stopper 132 may protrude so that both side surfaces of the second stopper 132 may have vertical planes.

The first pin unit 11 and the second pin unit 13 rotate together when the first stopper 112 and the second stopper 132 contact each other by engagement with respect to a rotation direction.

if the first pin unit 11 serving as an outer pin unit is rotated, the protruding side surface of the first stopper 112 comes into contact with the protruding side surface of the second stopper 132. Accordingly, the second stopper 132 rotates along with the first stopper 112, and thus when the first pin unit 11 rotates, the second pin unit 13 rotates together.

Here, the contact by engagement may mean that the side surface of the first stopper 112 makes a surface contact with the side surface of the second stopper 132 or that a protrusion formed at any one of the side surfaces of the first stopper 112 and the second stopper 132 contacts a groove formed at the side surface of the other one by fitting. The surface contact may mean a contact between surfaces which are inclined not to slide with respect to each other due to a predetermined static friction force between them.

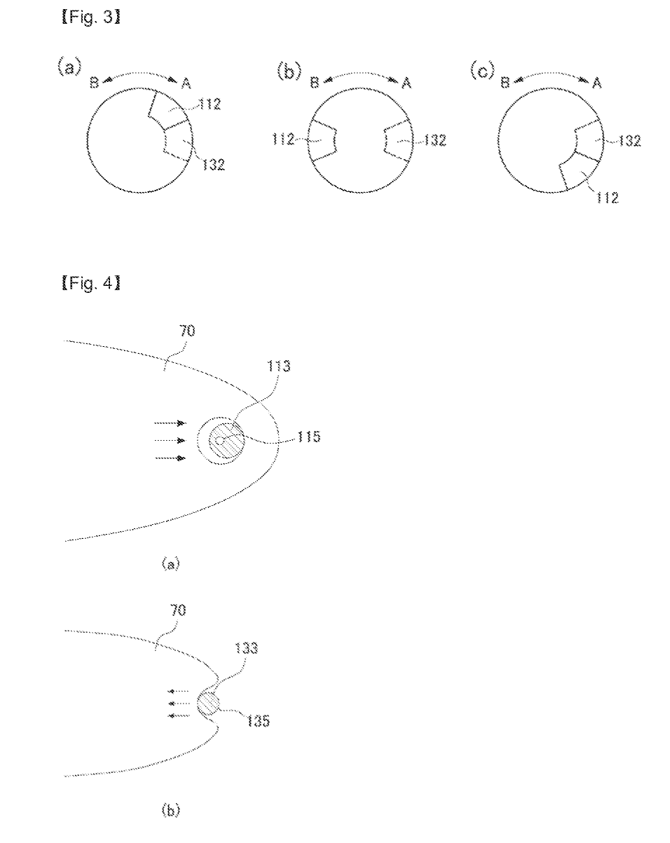

For example, referring to FIG. 3(a), if the first stopper 112 rotates in the A direction (clockwise direction), the vertical plane of the first stopper 112 may make a surface contact with the vertical plane of the second stopper 132. At this time, if the first pin unit 11 is further rotated in the A direction, the first stopper 112 continuously rotates in the A direction, and the vertical plane of the first stopper 112 contacts the vertical plane of the second stopper 132 by engagement, so that the second stopper 132 rotates together with the first stopper 112. In other words, after such a surface contact is made, if the first pin unit 11 is rotated, the second pin unit 13 rotates together, and thus it is possible to adjust the lens 70 coupled to the second pin unit 13 by operating only the first pin unit 11.

In FIG. 3(a), if the first stopper 112 rotates in the B direction (counterclockwise direction), referring to FIG. 3(b), since the surface contact between the vertical plane of the first stopper 112 and the vertical plane of the second stopper 132 is released, only the first pin unit 11 rotates, and the second pin unit 13 does not rotate. In other words, in a region where the surface contact is released as described above, if the first pin unit 11 is rotated, the second pin unit 13 does not rotate together. Therefore, by operating the first pin unit 11, it is possible to adjust only the lens 70 coupled to the first pin unit 11 without adjusting the lens 70 coupled to the second pin unit 13.

In FIG. 3(b), if the first pin unit 11 is further rotated in the B direction so that the first stopper 112 continuously rotates in the B direction, referring to FIG. 3(c), the vertical plane of the first stopper 112 makes a surface contact with the vertical plane of the second stopper 132 again, and if the first pin unit 11 is further rotated in the B direction, the second pin unit 13 rotates together. In other words, when a surface contact is made as described above, if the first pin unit 11 is rotated, the second pin unit 13 rotates together, and thus it is possible to adjust the lens 70 coupled to the second pin unit 13 by operating only the first pin unit 11.

In FIG. 3(c), if the first pin unit 11 is rotated in the A direction again, the surface contact between the vertical plane of the first stopper 112 and the vertical plane of the second stopper 132 is released, only the first pin unit 11 rotates and the second pin unit 13 does not rotate until it comes to the state of FIG. 3(a). in other words. In a region where the surface contact is released as described above, if the first pin unit 11 is rotated, the second pin unit 13 does not rotate together. Therefore, by operating only the first pin unit 11, it is possible to adjust only the lens 70 coupled to the first pin unit 11 without adjusting the lens 70 coupled to the second pin unit 13.

A method for adjusting the lens 70 coupled to the first pin unit 11 and the lens 70 coupled to the second pin unit 13 by rotating the first pin unit 11 is performed as follows. First, the first pin unit 11 is rotated in a state where the first stopper 112 and the second stopper 132 contact each other by means of engagement. In this case, the first pin unit 11 and the second pin unit 13 rotate together. First, the lens 70 coupled to the second pin unit 13 is adjusted so that the lens 70 coupled to the second pin unit 13 is coupled to the inner side of the shield 50 as tightly as desired by the wearer. If the lens 70 coupled to the second pin unit 13 is completely adjusted, the first pin unit 11 is rotated in a state where the contact by engagement between the first stopper 112 and the second stopper 132 is released. In this case, since only the first pin unit 11 rotates and the second pin unit 13 does not rotate, the lens 70 coupled to the first pin unit 11 is adjusted to be coupled to the outer side of the shield 50 as tightly as desired by the wearer.

In other words, the first pin unit 11 is rotated in a region where the first stopper 112 and the second stopper 132 contact by engagement so that the tightness of the lens 70 coupled to the second pin unit 13 is adjusted, and then the first pin unit 11 is rotated in a region where the contact by engagement between the first stopper 112 and the second stopper 132 is released so that the tightness of the lens 70 coupled to the first pin unit 11 is adjusted. In other words, the lens 70 coupled to the inner and outer sides of the shield 50 may be individually adjusted according to whether the first stopper and the second stopper contact by engagement.

In another example, when a protrusion is formed at the side surface of the first stopper 112 and a groove is formed at the side surface of the second stopper 132 to face the protrusion, if the first pin unit 11 is rotated so that the protrusion formed at the first stopper 112 is fit into the groove formed at the second stopper 132 to contact the second stopper 132 by engagement, the first pin unit 11 and the second pin unit 13 rotate together. Meanwhile, if the first pin unit 11 is rotated so that the protrusion formed at the first stopper 112 is separated from the groove formed at the second stopper 132, only the first pin unit 11 rotates and the second pin unit 13 does not rotate.

The first pin unit 11 may include a first pin eccentric shaft 113 which is eccentric with respect to the rotary shaft.

The first pin eccentric shaft 113 gives a place to which the lens 70 is coupled.

For example, as shown in FIGS. 1, 2 and 5, the first pin eccentric shaft 113 is formed to have a section smaller than the section of the first pin anti-separation unit 114 in order to prevent the lens 70 from being released.

At least one lens 70 may be coupled to the first pin eccentric shaft 113.

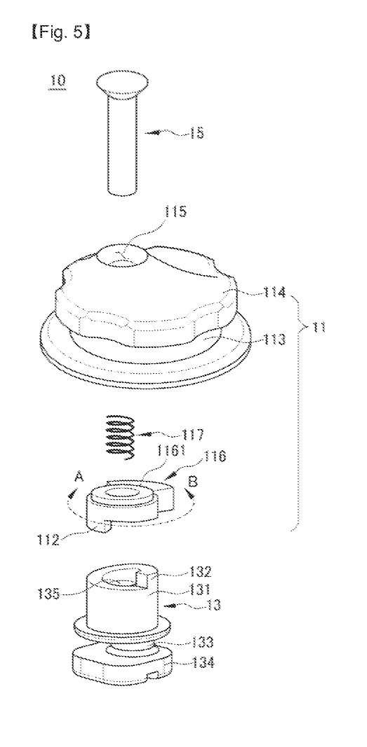

Referring to FIG. 4(a), when the first pin unit 11 is rotated so that the first pin eccentric shaft 113 is inclined to the rear of the helmet 1 based on the coupling hole 115 to which the coupling member 15 serving as a rotary shaft of the first pin unit 11 and the second pin unit 13 is coupled, a tensile force is applied to the lens 70 coupled to the first pin eccentric shaft 113 in a direction toward the rear of the helmet 1 (the arrow direction in FIG. 4(a)) so that the lens 70 may adjust the tightness of the lens 70 coupled to the first pin eccentric shaft 113. As described above, the wearer may adjust an adhesion of the lens 70 coupled to the first pin eccentric shaft 113 with respect to the shield 50 by rotating the first pin unit 11 so that the first pin eccentric shaft 113 is inclined to the rear of the helmet 1 based on the coupling hole 115.

Here, the coupling of the lens 70 includes both a case where the first pin eccentric shaft 113 passes through a hole formed in the lens 70 and a case where the first pin eccentric shaft 113 is fit into a groove formed at the lens 70.

As described above, referring to FIG. 4(a), in order to closely adhere the lens 70 coupled to the first pin eccentric shaft 113 to a convex outer surface of the shield 50, in general cases, the wearer should apply a tensile force to both ends of the lens 70 to pull both ends of the lens 70 toward the rear of the helmet 1. In order to apply such a tensile force to both ends of the lens 70, as described above, the first pin eccentric shaft 113 should be inclined to the rear of the helmet 1 based on the coupling hole 115 to which the coupling member 16 serving as a rotary shaft of the first pin unit 11 and the second pin unit 13 is coupled. At this time, a hole should be formed in the lens 70, and the first pin eccentric shaft 113 should be inserted into the hole so that the first pin eccentric shaft 113 may apply a tensile force to the lens 70 while pulling the hole. Therefore, if the first pin unit 11 is located out of the helmet 1 based on the shield 50, a hole may be formed in the lens 70 coupled to the first pin eccentric shaft 113 so that the lens 70 is coupled to the first pin eccentric shaft 113 through the hole.

In a racing game such as a bicycle race, impurities collide with the lens 70 at high speed, and thus the lens 70 is seriously damaged to hind the sight of the wearer. For this reason, a racer cannot endure the game just with one sheet of lens 70. Therefore, a plurality of lens 70 may be coupled to the first pin eccentric shaft 113, so that if an outermost lens 70 is damaged, the damaged lens 70 is detached as if the lens 70 is substituted with a new lens 70, thereby ensuring a good sight continuously.

The lens 70 coupled to the first pin eccentric shaft 113 may prevent the shield 50 from being exposed, outwards and thus damaged. In addition, the lens 70 coupled to the first pin eccentric shaft 113 may prevent the shield 50 from being stained due to dust or the like.

The first pin eccentric shaft 113 may have a length greater than the thickness of at least one lens 70.

Here, the length of the first pin eccentric shaft 113 corresponds to the thickness of the total lens 70 stacked in the length direction of the first pin eccentric shaft 113.

Since the first pin unit eccentric rotary shaft 113 has a length greater than the thickness of at least one lens 70 coupled to the first pin unit eccentric rotary shaft 113, when the first pin unit 11 is rotated to apply a tensile force to the lens 70 which is to be coupled to the first pin unit eccentric rotary shaft 113, the end of the lens 70 may be separated due to a compression force applied to the end of the lens 70 in an opposite direction, thereby facilitating easier attachment and detachment of the lens 70.

The first pin unit 11 may include a first pin ants-separation unit 114. When the fens 70 is coupled to the first pin eccentric shaft 113, the first pin anti-separation unit 114 may prevent the lens 70 from being separated.

In order to prevent the lens 70 coupled to the first pin eccentric shaft 113 from being separated, the first pin anti-separation unit 114 may be formed to have a greater section in comparison to the first pin eccentric shaft 113.

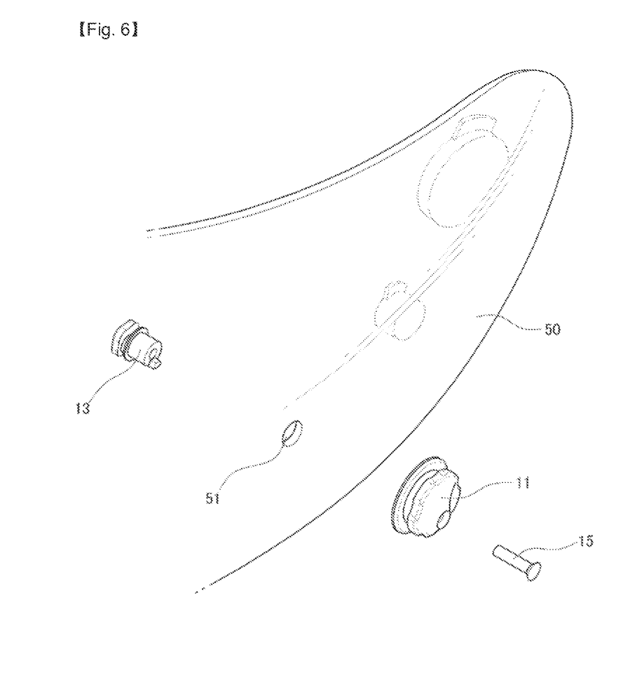

In addition, the first pin anti-separation unit 114 may serve as a handle so that a wearer of the helmet 1 may more easily rotate the first pin unit 11 to couple the lens 70. For example, the first pin anti-separation unit 114 may have a shape as shown in FIGS. 1 and 5 to ensure easier grip of the wearer.

The second pin unit 13 may include a second pin eccentric shaft 133 which is eccentric with respect to the rotary shaft.

Referring to FIG. 4(b), if the second pin eccentric shaft 133 rotates the first pin unit 11 to be inclined to the front of the helmet 1 based on the coupling groove 135 to which the coupling member 15 serving as a rotary shaft of the first pin unit 11 and the second pin unit 13 is coupled, a compression force is applied to the lens 70 coupled to the second pin eccentric shaft 133 in a direction toward the front of the helmet 1 (the arrow direction in FIG. 4(b)) to adjust the tightness of the lens 70 coupled to the second pin eccentric shaft 133. As described above, if the wearer rotates the first pin unit 11 to change a location of the second pin eccentric shaft 133, the lens 70 coupled to the second pin eccentric shaft 133 may be compressed to the shield 50 as desired.

As described above, referring to FIG. 4(b). In general cases, in order to compress the lens 70 coupled to the second pin eccentric shaft 133 to a concave-inner surface of the shield 50, the wearer should applies a force to both ends of the tens 70 toward the front of the helmet 1 to push the both ends of the lens 70. Therefore, a groove may be formed in the lens 70 coupled to the second pin eccentric shaft 133 as shown in FIG. 7 so that the lens 70 is coupled to the second pin eccentric shaft 133 through the groove.

The lens 70 coupled to the second pin eccentric shaft 133 may prevent the shield 50 from becoming humid and opaque due to breathing of the wearer.

In addition, the lens 70 coupled to the second pin eccentric shaft 133 may be made of plastic or the like having a shading function in order to protect the eyes of a driver by intercepting solar rays directly incident to the eyes at daytime and ensure a sufficient sight against strong sunlight or reflected light.

The second pin unit 13 may include a second pin anti-separation unit 134. The second pin anti-separation unit 134 may prevent the lens 70 from being separated when the lens 70 is coupled to the second pin eccentric shaft 133.

In order to prevent the lens 70 coupled to the second pin eccentric shaft 133 from being separated, the second pin anti-separation unit 134 may be formed to have a greater section than the second pin eccentric shaft 133.

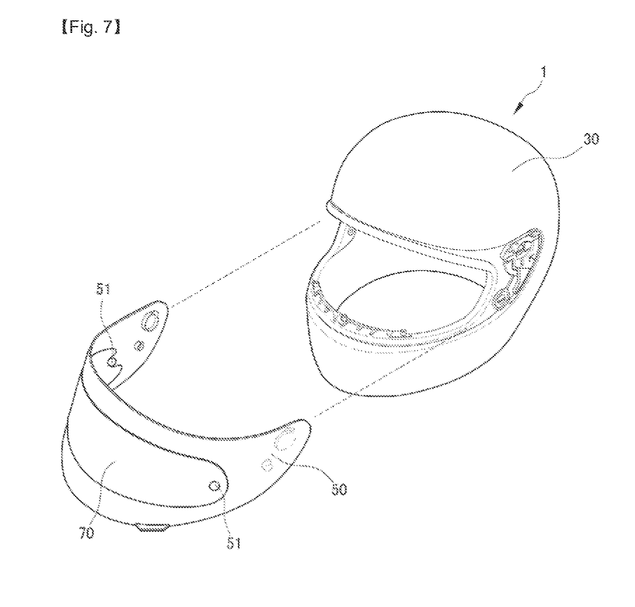

In addition, even though FIG. 8 shows that the second pin unit 13 is coupled to an inner portion of the helmet body 30 based on the shield 50, if the second pin unit 13 is located out of the helmet body 30 on the contrary to the above, the second pin anti-separation unit 134 may serve as a handle which allows the wearer of the helmet 1 to more easily rotate the second pin unit 13 and thus couple the lens 70. For example, the second pin anti-separation unit 134 may have a shape as shown in FIGS. 1 and 5 to ensure easier grip of the wearer.

An eccentric direction may be displayed at the second pin anti-separation unit 134.

Referring to FIGS. 1, 2, 5 and 8, the second pin unit 13 is smaller than the first pin unit 11. This allows the engagement groove 111 formed at the first pin unit 11 to accommodate the engagement protrusion 131 formed at the second pin unit 13, Therefore, if the second pin unit 13 has a so small size not to figure out a location of the eccentric, shaft, the eccentric direction may be displayed at the second pin anti-separation unit 134 located at the outermost end of the second pin unit 13, which may be easily observed by the wearer. By doing so, the wearer may be figure out a location of the eccentric shaft and couple the lens 70 more easily.

The pin lock apparatus 10 may include a coupling member 15.

As shown in FIGS. 1, 5 and 8, the coupling member 15 may integrally couple the first pin unit 11 and the second pin unit 13 through the lock fitting groove 51 formed in the shield 60.

When the coupling member 15 is used, if a force is applied to rotate the first pin unit 11 the second pin unit 13 rotates when the first stopper 112 and the second stopper 132 contact by engagement, without allowing the coupling between the first pin unit 11 and the second pin unit 13 to be released, and when the contact by engagement is released, the first pin unit 11 and the second pin unit 13 may be integrally coupled without allowing the second pin unit 13 to rotate. For example, by using the coupling member 15, the first pin unit 11 and the second pin unit 13 may be coupled with an interval so that the end of the first stopper 112 may not come into contact with the second pin unit 13 or the end of the second stopper 132 may not come into contact with the first pin unit 11 and thus does not generate a friction.

For example, if the coupling member 15 is a screw, the screw may be coupled to the second pin unit 13 by at least three turns in order to prevent the screw from being released.

The first pin unit 11 may have a coupling hole 115 through which the coupling member 15 passes. In addition, the second pin unit 13 may have a coupling groove 135 to which the coupling member 15 is coupled.

Referring to FIGS. 1, 5 and 6, if the coupling member 15 is coupled to the coupling groove 135 of the second pin unit 13 through the first pin unit 11, the first pin unit 11 and the second pin unit 13 may be integrally coupled.

In addition, the coupling member 15 may be coupled with the coupling hole 115. At this time, as shown in FIGS. 1, 5 and 8, since the first pin anti-separation unit 114 is formed with a slope, the first pin unit 11 may be provided to have a thickness which prevents screw releasing, for example which ensures screwing by at least three turns.

The bottom surface of the coupling groove 135 may serve as an insertion restriction surface which restricts a length of the coupling member 15 inserted into the coupling groove 135.

For example, as described above, by using the coupling member 15, without allowing the coupling between the first pin unit 11 and the second pin unit 13 to be released, when the first pin unit 11 is rotated, the second pin unit 13 rotates if the first stopper 112 and the second stopper 132 contact by engagement, and when the contact by engagement is released, the first pin unit 11 and the second pin unit 13 may be coupled without allowing the second pin unit 13 to rotate.

At this time, the first pin unit 11 and the second pin unit 13 may be coupled so tightly not to be released if the periphery of the coupling member 15 comes info contact with the peripheries of the first pin unit 11 and the second pin unit 13 and a front end of the front surface of the coupling member 15 comes into contact with the insertion restriction surface formed at the second pin unit 13.

Here, the contact of peripheries may mean that, for example, a thread formed at the periphery of the coupling member 15 comes into contact with a thread formed at the periphery of the coupling hole 115 of the first pin unit 11 and a thread formed at the periphery of the coupling groove 135 of the and second pin unit 13 by screwing.

In addition, the contact of front ends may mean that the coupling member 15 comes into contact with the insertion restriction surface so that the insertion restriction surface restricts an insertion of the coupling member 15 into the coupling groove 135 to cause a friction between the insertion restriction surface and the front surface of the coupling member 15. This contact of front ends may give a front end friction between the insertion restriction surface and the front surface of the coupling member 15 in addition to the above contact of peripheries to prevent the coupling between the first pin unit 11 and the second pin unit 13 from being released.

Meanwhile, hereinafter, operations of the pin lock apparatus 1 when the first stopper 112 and the second stopper 132 are configured to protrude with a different shape from the above will be described.

Referring to FIG. 5, the first stopper 112 has one surface which contacts the second stopper 132 by engagement and the other surface which is an inclined surface formed along a circumferential direction. In addition, the second stopper 132 has one surface which is an inclined surface formed along a direction opposite to the circumferential direction and the other surface which contacts the first stopper 112 by engagement.

At this time, referring to FIG. 5, the circumferential direction and the direction opposite to the circumferential direction are determined so that, when being observed from an upper side (an upper side in FIG. 5) based on the rotary shaft of the first pin unit 11 and the second pin unit 13, one direction is set as a circumferential direction and a direction opposite to the circumferential direction is set as an opposite direction.

Here, the contact by engagement may mean surface contact or fitting surface as described above.

The bottom surface of the engagement groove 111 may be elastically moved toward the rotary shaft so that the inclined surface of the second stopper 132 may slide along the inclined surface of the first stopper 112.

Referring to FIG. 5, if the first pin unit 11 rotates further in the B direction, the first pin unit 11 slides down along the inclined surface of the second pin unit 13, and accordingly the bottom surface of the engagement groove 111 may be elastically relaxed. If the bottom surface of the engagement groove 111 is elastically relaxed, the vertical plane of the first stopper 112 makes a surface contact with the vertical plane of the second stopper 132 so that the second pin unit 13 rotates together with the first pin unit 11. Therefore, if the first pin unit 11 is rotated in the B direction as described above, the second pin unit 13 rotates together, and thus it is possible to adjust the lens 70 coupled to the second pin unit 13 by operating just the first pin unit 11.

Meanwhile, referring to FIG. 5, if the first pin unit 11 rotates in the A direction, the first pin unit 11 slides up along the inclined surface of the second pin unit 13, and accordingly the bottom surface of the engagement groove 111 may be elastically compressed. If the bottom surface of the engagement groove 111 is elastically compressed, the surface contact between the vertical plane of the first stopper 112 and the vertical plane of the second stopper 132 is released so that only the first pin unit 11 rotates and the second pin unit 13 does not rotate. Therefore, if the first pin unit 11 is rotated in the A direction as described above, only the first pin unit 11 rotates, and thus it is possible to adjust only the lens 70 coupled to the first pin unit 11 by rotating the first pin unit 11.

As described above, since the bottom surface of the engagement groove 111 serves a cushion role by elastically moving (compression and relaxation) according to the rotation of the first pin unit 11, after adjusting the tightness of the lens 70 coupled to the second pin unit 13 by rotating the first pin unit 11 in the B direction, the tightness of the lens 70 coupled to the first pin unit 11 may be adjusted by rotating the first pin unit 11 in the A direction. In this way, the lens 70 respectively coupled to the first pin unit 11 and the second pin unit 13 may be individually adjusted.

When the first stopper 112 and the second stopper 132 as show in FIGS. 1 and 2 are used, if the first pin unit 11 is rotated, the first pin unit 11 and the second pin unit 13 rotate together in a region where the first stopper 112 and the second stopper 132 contact by engagement, and only the first pin unit 11 rotates in a region where the contact by engagement between the first stopper 112 and the second stopper 132 is released. In other words, the second pin unit 13 may be rotated or not according to a rotation region of the first pin unit 11.

Meanwhile, when the first stopper 112 and the second stopper 132 as shown in FIG. 5 are used, only the first pin unit 11 rotates if the first pin unit 11 rotates in a direction of sliding up along the inclined surface of the second pin unit 13, and the first pin unit 11 and the second pin unit 13 rotate together if the first pin unit 11 rotates in a direction of sliding down along the inclined surface of the second pin unit 13. In other words, the second pin unit 13 may be rotated or not according to a rotation direction of the first pin unit 11.

For example, referring to FIG. 5, the first pin unit 11 may include a bottom unit 116 which embraces the bottom surface of the engagement groove 111.

Referring to FIG. 5, the bottom unit 118 may have a rotation limiting protrusion 1161 protruding on a periphery thereof. In addition, the engagement groove 111 may have a rotation limiting groove (not shown) formed in a periphery thereof to be engaged with the rotation limiting protrusion 1161 in order to restrict a rotation of the bottom unit 116.

In addition, the first pin unit 11 may include an elastic member 117 for elastically moving the bottom unit 116. For example, the elastic member 117 may be a spring.

If the first pin unit 11 is rotated, the rotation limiting protrusion 1161 is engaged with the rotation limiting groove, and thus the bottom unit 116 may rotate together. As described above, the first pin unit 11 and the bottom unit 116 may rotate integrally by means of the rotation limiting protrusion 1161 and the rotation limiting groove.

The number of rotation limiting protrusions 1161 may correspond to the number of rotation limiting grooves. For example, referring to FIG. 5, a single rotation limiting protrusion 1161 may be provided, and also a single rotation limiting groove may be formed to be engaged with the single rotation limiting protrusion 1161.

Referring to FIG. 5, if the first pin unit 11 is rotated in the B direction, the bottom unit 116 also rotates in the B direction, and thus the first stopper 112 slides down along the inclined surface of the second stopper 132. At this time, if the first pin unit 11 is rotated in the B direction further, the vertical plane of the first stopper 112 comes info contact with the vertical plane of the second stopper 132 by engagement, and the elastic member 117 is relaxed so that the second pin unit 13 rotates together with the first pin unit 11. Therefore, if the first pin unit 11 is rotated in the B direction as described above, the second pin unit 13 rotates together, and thus it is possible to adjust the lens 70 coupled to the second pin unit 13 by operating only the first pin unit 11.

Meanwhile, if the first pin unit 11 is rotated in the A direction, the bottom unit 116 also rotates in the A direction, and thus the first stopper 112 slides up along the inclined surface of the second stopper 132. At this time, if the first pin unit 11 is rotated in the A direction further, the contact by engagement between the vertical plane of the first stopper 112 and the vertical plane of the second stopper 132 is released, and the elastic member 117 is compressed so that only the first pin unit 11 rotates. Therefore, if the first pin unit 11 is rotated in the A direction, only the first pin unit 11 rotates, and thus if is possible to adjust only the lens 70 coupled to the first pin unit 11 by rotating the first pin unit 11.

As described above, since the elastic member 117 elastically moves (compression and relaxation) according to a rotation direction of the first pin unit 11, after adjusting the tightness of the lens 70 coupled to the second pin unit 13 by rotating the first pin unit 11 in the B direction, the tightness of the lens 70 coupled to the first pin unit 11 may be adjusted by rotating the first pin unit 11 in the A direction. In this way, the tens 70 respectively coupled to the first pin unit 11 and the second pin unit 13 may be individually adjusted.

In the pin lock apparatus 1, by rotating the first pin unit 11 to adjust the contact by engagement between the first stopper 112 and the second stopper 132, it is possible to rotate only one of the first pin unit 11 and the second pin unit 13 or to rotate both the first pin unit 11 and the second pin unit 13, and thus the tightness of the lens 70 coupled to the pin lock apparatus 1 at the inner and outer sides of the shield 50 may be individually adjusted. In addition, by rotating the first pin unit 11 to adjust locations of the first pin eccentric shaft 113 and the second pin eccentric shaft 133, it is possible to adjust the lens 70 coupled at the inner and outer sides of the shield 50 to be adhered or compressed to the shield 50 as desired. Therefore, the lens 70 may be coupled to the inner and outer sides of the shield 50 in an optimal way as desired by the wearer.

in addition, since the front surface of tie coupling member 15 is coupled to come into contact with the insertion restriction surface provided at the second pin unit 13, when a force is applied to rotate the first pin unit 11 the second pin unit 13 may rotate together, and simultaneously the coupling member 15 may be coupled to the first pin unit 11 and the second pin unit 13 to satisfy suitable tightness for allowing the first pin unit 11 and the second pin unit 13 not to be released.

In addition, since an eccentric direction is displayed at the second pin anti-separation unit 134, a location of the eccentric shaft may be easily figured out, which ensures convenience in adjusting the tightness of the coupled lens.

In addition, since the first pin eccentric shaft 113 has a length greater than the thickness of at least one lens 70 coupled to the first pin eccentric shaft 113, if a tensile force is applied to the lens 70 coupled to the first pin eccentric shaft 113 by rotating the first pin unit 11, the end of the lens 70 may be separated due to a compression force applied to the end of the lens 70, thereby facilitating easier attachment and detachment of the lens 70.

Even though it has been assumed in the above embodiments that the first pin unit 11 is an outer pin unit and the second pin unit 13 is an inner pin unit, it is also possible that the first pin unit 11 is an inner pin unit and the second pin unit 13 is an outer pin unit, contrary to the above.

Meanwhile, a helmet 1 according to an embodiment of the present disclosure (hereinafter, also referred to as ‘the helmet’) will be described. However, any component similar or identical to that of the pin lock apparatus 10 according to an embodiment of the present disclosure, described above, will be designated with the same reference numeral and is not described in detail.

The helmet 1 includes a helmet body 30.

Referring to FIG. 7, the helmet body 30 has an inner space in which the head of a wearer is accommodated and may have a sealed shape suitable for the head shape of the wearer.

in addition, an opening may be formed at the front of the helmet body 30 to ensure a front sight

The helmet 1 includes a shield 50.

The shield 50 is coupled to the opening so that the sight is not disturbed due to wind, rain or snow from the front in running. Referring to FIG. 7, the shield 50 may be coupled to be selectively opened or may also be attached to the helmet body 30.

The shield 50 is made of transparent or translucent material.

An elastic member (not shown) such as rubber may be coupled to the upper portion of the shield 50 in order to relieve an impact applied to the shield 50 when the shield 50 collides with the helmet body 30.

The helmet 1 includes the pin lock apparatus 10.

Referring to FIG. 7, the pin lock apparatus 10 may be coupled to both sides of the shield 50 by means of the lock fitting groove 51, without being limited thereto.

The lock fitting groove 51 represents a hole having a diameter which is accommodated in the first pin unit 11 through the second pin unit 13 and allows rotation in a clockwise direction or a clockwise direction.

A bearing (not shown) may be coupled along the periphery of the lock fitting groove 51. When the pin lock apparatus 1 rotates in a state of being coupled to the shield 50, the bearing may absorb a frictional force caused by the rotation and facilitate better rotation.

For example, the pin lock apparatus 10 may be coupled to upper and lower portions of the shield 50. At this time, the pin lock apparatus 10 may be coupled at a location out of the sight in order not to disturb the sight of the wearer.

The wearer may wear the helmet 1 and then also wear the lens 70 easily respectively at the inner and outer sides of the shield 60.

The helmet 1 may include the lens 70 coupled to the first pin unit 11. In addition, the helmet 1 may include the lens 70 coupled to the second pin unit 13.

For example, if the first pin unit 11 is located out of the helmet body 30 based on the shield 50, at least one lens 70 for preventing the shield 50 from being damaged may be coupled to the first pin eccentric shaft 113, and at least one lens 70 for preventing moisture may be coupled to the second pin eccentric shaft 133.

The lens 70 coupled to the first pin unit 11 and the second pin unit 13 may be made of transparent or translucent material with flexibility.

The above description of the present disclosure is just for illustration, and a person skilled in the art will understand that the present disclosure can be easily modified in different ways without changing essential techniques or features of the present disclosure. Therefore, the above embodiments should be understood as being descriptive, not limitative. For example, any component described as having an integrated form may be implemented in a distributed form, and any component described as having a distributed form may also be implemented in an integrated form.

The scope of the present disclosure is defined by the appended claims, rather than the above description, and ail changes or modifications derived from the meaning, scope and equivalents of the appended claims should be interpreted as falling within the scope of the present disclosure.

1. A pin lock apparatus of a shield coupled to a helmet body, the apparatus comprising:
a first pin unit having an engagement groove and a first stopper protruding on a bottom surface of the engagement groove; and
a second pin unit having an engagement protrusion engaged with the engagement groove and a second stopper protruding on an end surface of the engagement protrusion, the second pin unit being coupled to the first pin unit through a lock fitting groove formed in the shield,
wherein the first pin unit and the second pin unit rotate together when the first stopper and the second stopper contact each other by engagement with respect to a rotation direction.

2. The pin lock apparatus according to claim 1,
wherein the first pin unit includes a first pin eccentric shaft which is eccentric with respect to a rotary shaft.

3. The pin lock apparatus according to claim 2,
wherein at least one lens is coupled to the first pin eccentric shaft, and
wherein the first pin eccentric shaft has a length greater than a thickness of the at least one lens,

4. The pin lock apparatus according to claim 2,
wherein the first pin unit includes a first pin anti-separation unit configured to prevent the lens from being separated when the lens is coupled to the first pin eccentric shaft.

5. The pin lock apparatus according to claim 1
wherein the second pin unit includes a second pin eccentric shaft which is eccentric with respect to a rotary shaft.

6. The pin lock apparatus according to claim 6,
wherein the second pin unit includes a second pin anti-separation unit configured to prevent the lens from being separated when the lens is coupled to the second pin eccentric shaft.

7. The pin lock apparatus according to claim 6,
wherein an eccentric direction is displayed at the second pin anti-separation unit.

8. The pin lock apparatus according to claim 1, further comprising:
a coupling member configured to integrally couple the first pin unit and the second pin unit by means of the lock fitting groove.

9. The pin lock apparatus according to claim 8,
wherein the first pin unit has a coupling hole through which the coupling member passes,
wherein the second pin unit has a coupling groove to which the coupling member is coupled, and
wherein a bottom surface of the coupling groove serves as an insertion restriction surface which restricts a length of the coupling member inserted into the coupling groove.

10. The pin lock apparatus according to claim 1,
wherein one side surface of the first stopper contacts the second stopper by engagement, and the other side surface of the first stopper is an inclined surface formed along a circumferential direction,
wherein one side surface of the second stopper is an inclined surface formed along a direction opposite to the circumferential direction, and the other side surface of the second stopper contacts the first stopper by engagement, and
wherein the bottom surface of the engagement groove is elastically moved toward the rotary shaft so that the inclined surface of the second stopper slides along the inclined surface of the first stopper.

11. The pin lock apparatus according to claim 10.
wherein the first pin unit includes:
a bottom unit including the bottom surface of the engagement groove; and
an elastic member configured to elastically move the bottom unit.

12. The pin lock apparatus according to claim 11,
wherein a rotation limiting protrusion protrudes on a periphery of the bottom unit, and
wherein the engagement groove has a rotation limiting groove which is engaged with the rotation limiting protrusion to limit rotation of the bottom unit.

13. A helmet, comprising:
a helmet body;
a shield; and
a pin lock apparatus defined in the claim 1.

14. The helmet according to claim 13, further comprising:
a fans coupled to at least one of the first pin unit and the second pin unit.
